(19) United States
(12) Patent Application Publication
(10) Pub. No.: US 2004/0252485 A1
(43) Pub. Date: Dec. 16, 2004

(54) Diffusion board having different areas with different refractive indices

(76) Inventors: Charles Leu, Fremont, CA (US); Tai-Cherng Yu, Tu-Chen (TW); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/813,408

(22) Filed: Mar. 29, 2004

(30) Foreign Application Priority Data
Mar. 28, 2003 (TW) 92107177

(51) Int. Cl. F21V 9/16

(52) U.S. Cl. 362/84

(57) ABSTRACT

Provided is a liquid crystal display, comprises light sources (220) projecting light beam therefrom according to its contour. A diffusion board (230) is arranged with respect to the light source so as to diffuse the light beam projected thereon. The diffusion board has an incident surface and includes fluorescent sections with respect to the contour of the light sources.

### BACKGROUND OF THE INVENTION

1. Field of the Invention

The present invention relates to a diffusion board, and more particularly to a diffusion board having diffusion sections with different refractive indices, thereby creating a homogeneous luminance distribution across a liquid crystal display lit by the diffusion board.

2. Description of Prior Art

A liquid crystal display is capable of displaying a clear and sharp image over a wide area. It is thus used with various devices in which a message or picture needs to be illustrated. However, a liquid crystal itself does not emit light, therefore, it has to be back-lit by a light source to display the messages and/or pictures shown there.

In an ideal liquid crystal display, the backlight most provide light evenly distributed across the entire surface. In addition, the apparatus has to meet the requirements of being small in size, light in weight, bright enough with low power consumption.

U.S. Pat. No. 5,438,484 issued to Kanda et al. discloses a surface lighting device. A variety of prior art surface lighting devices are disclosed in FIGS. 1 to 5 of the Kanda patent. The light source arranged in the surface lighting device shown is generally referred to as an “edge-type light source”. Kanda describes the disadvantages of the prior art surface lighting device in detail, i.e. the surface area closer to the light sources are brighter than the central area. According to Kanda's explanation in the specification, “However, as described above, the surface lighting device of an edge type has a low luminance in the central portion between the light sources and a high luminance in the vicinity of the light sources as indicated by a broken line C shown in FIG. 9. This is because the light sources 1a and 1b emit diffusion light and make the vicinity of the light sources 1a and 1b bright while the light emitted from the light sources 1a and 1b mostly reach the opposite light source 1b and 1a to be diffused, respectively, thus making the vicinity of the light sources 1a and 1b brighter. As a result, it is inevitable that the effective light range (effective emission surface) of the foregoing lighting device will become narrower because its overall luminance must be adjusted to latch evenly as a backlight with the lowered luminance between the central portion between the light sources 1a and 1b. Thus, a problem is encountered that the light utilization efficiency for the apparatus as a whole is reduced.” See Column 2, lines 31 to 49.

Kanda provides a solution, such as shown in FIGS. 11 to 16, by providing “a light guide configured by a plural light transmitting members joined together, so that the junction surface therebetween crosses the light emitting surface.” As a result and according to Kanda, the luminance emitted from edge-type light sources is evenly distributed across the entire area.

Kanda provides another solution in FIGS. 17 to 23, typically shown in FIG. 23. In this application, the light source is arranged directly behind the liquid crystal display, instead of at the edge of a light guide, as shown in FIG. 1 of the Kanda patent. However, this arrangement indeed provides a brighter central displaying area, but creates a problem of color chromaticity across the liquid crystal display. As explained by Kanda in Column 12, lines 19-49. Kanda then uses a “light source having preferably be more blueish than the standard color” to solve the “yellowish” problem.

Aside from use of the “blueish light source”, it is noted that a “light curtain”, reference numeral 14 of FIG. 22, has also been used to reduce the luminance projected toward the display area immediately in front of the light source. It should be easy to appreciate that the more parts used within the liquid crystal display, the more laborious the effort needed to assemble the display. No doubt, the size and weight of the liquid crystal display will inevitably be increased.

U.S. Pat. No. 5,881,201 issued to Khanarian discloses improved lightpipes for backlighting liquid crystal display devices. The lightpipes comprise transparent polymers with scattering centers. A preferred composition for such lightpipes comprises a cycloolefin polymer containing scattering centers from suitable elastomers and inorganic fillers. The inventive lightpipes offer superior scattering efficiency as well as spatial uniformity of scattering and uniformity of scattering across a wide wavelength range.

U.S. Pat. No. 5,881,201 issued to Khanarian discloses an improved lightpipe for backlighting applications in liquid crystal display devices. The lightpipes comprise transparent polymers with scattering centers. According to Khanarian, the scattering centers are evenly distributed within the entire lightpipe so as to increase the luminance refractive therefrom.

### SUMMARY OF THE INVENTION

It is an object of the present invention to provide a diffusion board for being back-lit by light sources, the diffusion board having first areas and second areas, wherein the first areas are mixed with fluorescent material thereby effectively diverting light beams projected directly from the light sources to provide a uniform light.

In order to achieve the object set forth, a liquid crystal display comprises a light source projecting light beams therefrom according to its contour and a diffusion board arranged with respect to the light sources so as to diffuse the light beams projected thereinto. The diffusion board has an incident surface and includes different areas having different densities of fluorescent materials, the areas being positioned to correspond with the contour of the light source.

### BRIEF DESCRIPTION OF THE DRAWINGS

FIG. 1 is a perspective view of a liquid crystal display made in accordance with the present invention;

FIG. 2 is a cross-sectional view of a diffusion board made in accordance with the present invention shown in FIG. 1; and

FIG. 3 is a cross-sectional view of a second embodiment of a diffusion board made in accordance with the present invention;

FIG. 4 is a cross-sectional view of a third embodiment of a diffusion board made in accordance with the present invention; and

FIG. 5 is a top view of a light source of a liquid crystal display made in accordance with the present invention shown in FIG. 1.

### DETAILED DESCRIPTION OF PREFERRED EMBODIMENTS OF THE INVENTION

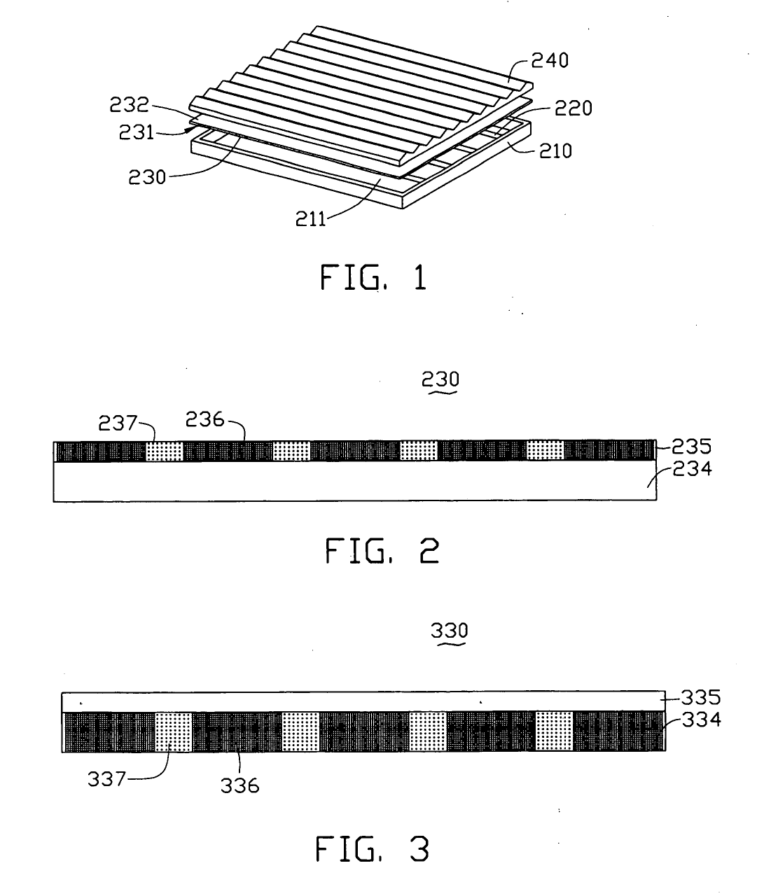

Referring to FIGS. 1 and 2, a liquid crystal display made in accordance with the present invention generally includes a refractor frame 210 in which a plurality of light sources 220 is arranged. The refractor frame 210 further includes a diffusion board 230, and an enhancer 240.

The diffusion board 230 defines an incident surface 231 and an emitting surface 232. The light sources 220 are arranged adjacent to the incident surface 231, while the enhancer 240 is arranged adjacent to the emitting surface 232. The refractor frame 210 is further coated with a reflective film 211 so as to increase the luminance of the light sources 220 by reflecting the light beams emitted therefrom.

As mentioned in the prior art, when the light sources 220 are arranged right under the diffusion board 230, it is very much likely that a viewer may see the “shadow” of the light because the light beam projects directly toward the diffusion board 230. In order to effectively eliminate this unwanted defective shadow, the diffusion board 230 made in accordance with the present invention provides a genuine diffusion board 230 so as to soften the “shadow”, thereby providing a shadow-free image by completely diffused the light beam projected thereon.

Referring to FIG. 2, the diffusion board 230 generally comprises a substrate 234 which is made from high transparent material. The diffusion board 230 further includes a diffusion layer 235 formed directly upon the substrate 234. The diffusion layer 235 is made from the following material, such as Polymethyl Methacrylate (known as PMMA), Polycarbonate (known as PC). The PMMA or PC is further blended with scattering material so as to increase the refractive efficiency therein. The scattering material is selected from Melamine Resin or PMMA having a grain size of 5 to 30 micrometers.

Specially, when the diffusion layer 235 is formed, the diffusion layer 235 is configured at least by a first areas 236, and a second areas 237. Mostly, the second areas 237 is closer to the light source 220, while the first areas 236 is away from the light source 220. In order to eliminate the shadow generated by the light source, the refractive index in the second areas 237 is comparably larger than the first areas 236. By this arrangement, the light projected through the second areas 237 will be scattered such that the shadow effect is faded away.

According to a preferable embodiment in accordance with the present invention, the diffusion board 230 is made through an injection process. The diffusion board 230 is made such that the first areas 236 and the second areas 237 are injected with different material. For example, the first areas 236 is injected with normal transparent material, while the second areas 237 is mixed with the scattering material, i.e. melamine resin or PMMA having a grain size of 5 to 30 micrometers. Those two material will precisely mixed within the mold cavity. As a result, the second areas 237 is composed with high density of scattering material, i.e. higher refractive index. By this arrangement, the light beam projected directly from the light source is effectively diffused within the diffusion board 230, thereby by eliminating the shadow of light.

It can be easily appreciated the by providing with the diffusion board 230 with area having different refractive index, the light shadow can be effectively eliminated without the use of a light curtain, such as described in U.S. Pat. No. 5,438,484 issued to Kanda.

As mentioned above, scattering materials having a higher refractive index can be used, however, such scattering materials can be replaced with fluorescent materials to provide different refractive indices in the first areas 236, and the second areas 237. Preferably, the second areas 237 can be mixed with a certain amount of fluorescent material so as to achieve a higher refractive index, while the first areas 236, which are not as close to the light source, can be made directly from the melamine resin or PMMA having a grain size of 5 to 30 micrometers, or another suitable grain size. As such, the second areas 237, which have the higher refractive index and directly faces the light sources diffuse the light beams directly projected thereinto. Accordingly, the shadow effect can be effectively eliminated.

Although the embodiment disclosed above discloses the use of fluorescent material mixed with transparent material, it can be readily appreciated that the diffusion layer 235 can be formed as a film material mixed with fluorescent material. Alternatively, the fluorescent material can be coated over certain areas of the diffusion board 230 so as to create areas with different refractive indices so as to eliminate the light “shadows”. The method for making a layer of fluorescent material over the diffusion board can include directly coating, using vapor deposition, vacuum coating, or spraying. The fluorescent material can be selected from a number of materials, such as green, red and orange fluorescent dyes.

In use, the light beams projected from the light sources 220 and reflected by the reflective film 211 penetrates into the diffusion board 230, which diffuses the light beams evenly across the diffusion board 230. As the refractive indices between the first areas 236 and the second areas 237 are specially tailored, the light emitted from the emitting surface 232 is evenly distributed. As mentioned above, the second areas 237 are right above the light sources 220, and have a large fluorescent refractive index, which results from the additional fluorescent material, so the light beams penetrating thereinto are largely diffused and become light beams with random directions. The light beams are then evenly emitted from the emitting surface 232, and enter the enhancer 240, which to intensifies its luminance. By this arrangement, the light beams projected from the light sources are largely intensified.

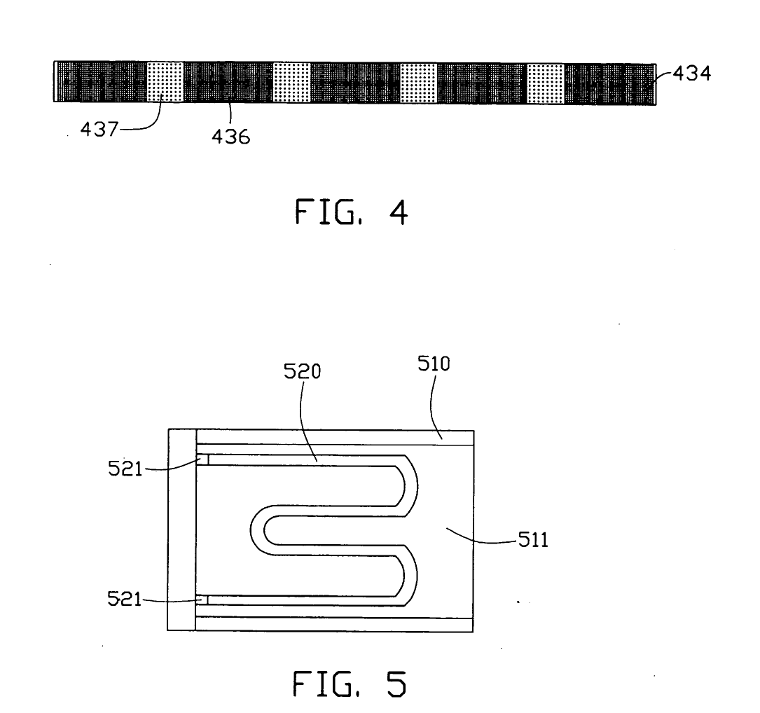

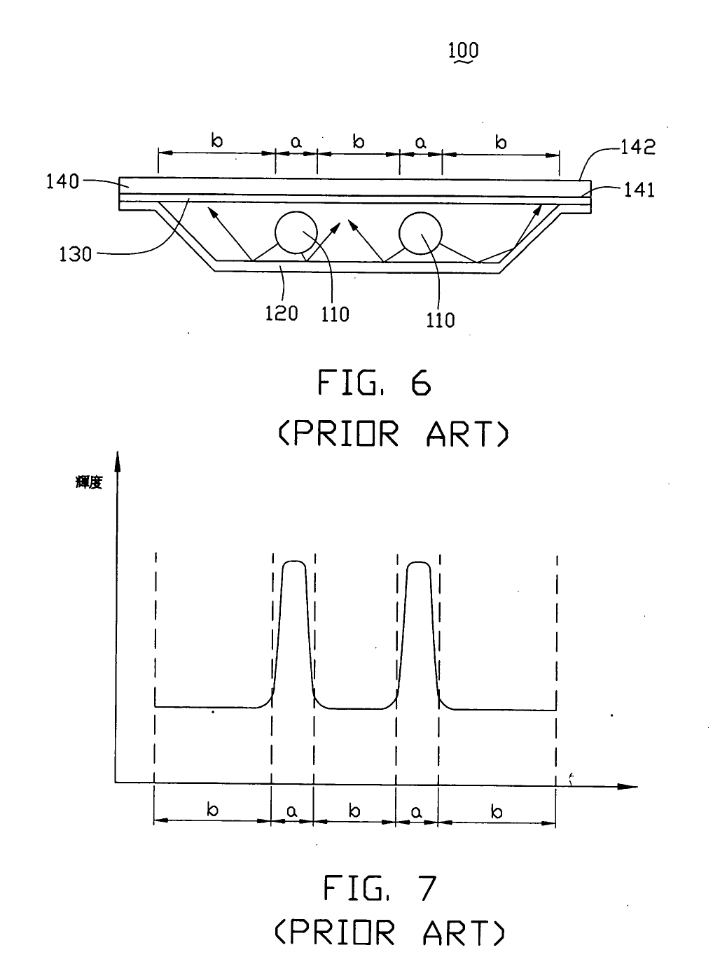

As shown in FIG. 3, a diffusion board 330 in accordance with the a second embodiment of present invention includes a substrate 335 and a diffusion layer 334. The substrate 335 is a composite layer featuring on enhancing film. The diffusion layer 334 is made from transparent material with fluorescent material (not labeled) mixed therein. The fluorescent material is distributed according to a preset pattern, i.e., with respect to light sources to be faced. As shown in FIG. 4, the diffusion layer 334 includes first areas 336, and second areas 337 facing the light sources 220 (see FIG. 1). The density of the fluorescent material with the first areas 336 and the second areas 337 are specially tailored so as to achieve a uniform luminance distribution over the whole diffusion board 330. In the second embodiment, the second areas 337 are more refractive, while the first areas 336 are less refractive so as to achieve a homogenous luminance distribution.

Referring to FIG. 4, a diffusion board 434 in accordance with a third embodiment of the present invention is made from transparent material using insert molding. The transparent material is mixed with fluorescent material (not labeled). The fluorescent material within the transparent material is specially tailored with respect to the light sources 220 (see FIG. 1) so that first areas 436 and second areas 437 are formed with respect to the light sources 220. Again, the density of the fluorescent material in the first areas 336 and in the second areas 337 is specially tailored so as to achieve a uniform luminance distribution. In this embodiment, the second areas 437 are more refractive as they directly face the light sources, while the first areas 336 is less refractive so as to achieve a homogenous luminance distribution. The diffusion board 434 can be further machined so as to achieve the preferred performance.

As shown in FIG. 5, a light source 520 is arranged within a refractor frame 510 and has a W-shape configuration. The refractor frame 510 is further coated with a reflective film 511 so as to intensify the luminance. The W-shape light source 520 includes a pair of electrodes 521 for powering the light source. Since the W-shape light source 520 projects a W-shape light beam, the fluorescent material arranged in the diffusion board is tailored so as to have the same contour. As a result, the “shadow” effect is again eliminated by the provision of scattering material within the diffusion board.

The embodiments described above are relate to a penetrative type light source, i.e., the light source is arranged under the diffusion board. In cases of side-edge arranged light sources, the basic arrangement provided by the present invention can also be applied.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A liquid crystal display, comprising:
a diffusion board having an emitting surface and an incident surface; and
at least a light source arranged behind the incident surface;
wherein the diffusion board forms at least two areas, each area having a different density of fluorescent material mixed therein to provide a different index of refraction, each area corresponding in shape to the contour of the light source, thereby eliminating a shadow image viewed from the liquid crystal display.

2. The liquid crystal display as recited in claim 1, wherein the areas are formed by mixing transparent material with fluorescent material, thereby providing differing diffusion capabilities.

3. The liquid crystal display as recited in claim 1, further comprising a light enhancing plate to intensify the luminance emitted from the diffusion board.

4. The light crystal display as recited in claim 1, wherein the intensified diffusion section is formed by fluorescent particulates.

5. A liquid crystal display, comprising:
a light source projecting light beams therefrom according to its contour; and
a diffusion board arranged with respect to the light source so as to diffuse the light beams projected thereinto, the diffusion board having an incident surface;
wherein the diffusion board includes fluorescent areas with respect to the contour of the light source.

6. A liquid crystal display comprising:
a diffusion board defining an incident surface; and
a light source located behind the diffusion board and emitting light toward the incident surface in a direction perpendicular to said incident surface, said light source defining a specific contour thereof; wherein
the diffusion board is made to be equipped with fluorescent material inherently under a condition that the fluorescent material in areas of said diffusion board in alignment with the light source in said direction, is thinner than those in other areas thereof.
